(19) United States
(12) Patent Application Publication
(10) Pub. No.: US 2026/0309193 A1
(43) Pub. Date: Oct. 8, 2026

(54) SPATIALLY ELASTIC COUPLING AND COUPLING ARRANGEMENT

(71) Applicant: KWD KUPPLUNGSWERK DRESDEN AG, Dresden (DE)

(72) Inventors: Thomas HÄHNEL, Wilsdruff (DE); Julius SCHNEIDER, Dresden (DE)

(73) Assignee: KWD KUPPLUNGSWERK DRESDEN AG, Dresden (DE)

(21) Appl. No.: 19/480,761

(22) PCT Filed: Apr. 29, 2024
(86) PCT No.: PCT/EP2024/061753

§ 371 Date: Oct. 31, 2025

(30) Foreign Application Priority Data
May 2, 2023 (DE) 20 2023 102 375.4

(51) Int. Cl. F16D 3/72

(52) U.S. Cl. CPC F16D 3/72

(57) ABSTRACT

A spatially elastic coupling is provided for connecting a driving unit and a driven unit, including at least a first and second connecting element extending radially to the axis of rotation, and at least one rotationally symmetrical torsionally and flexurally elastic stiffness module. The first and second connecting elements are arranged coaxially to one another and are connected by the torsionally and flexurally elastic stiffness module and the torsionally and flexurally elastic stiffness module extends coaxially to the axis of rotation of the coupling. The coupling can be used between two shafts to be connected or in conjunction with other types of coupling.

The invention relates to the technical fields of mechanical engineering and coupling technology and concerns a spatially elastic coupling and a coupling arrangement formed from spatially elastic couplings, which can be used to transmit a torque from a drive side to an output side between two machine parts. The spatially elastic coupling can be used for example between two shafts to be connected, but also in conjunction with a tooth coupling, flange coupling, ring disk coupling, link coupling, all-metal coupling, diaphragm coupling, lamellar coupling, friction coupling or combination couplings, for example in vehicle drives, in particular rail vehicle drives.

Couplings are well known from the prior art. They are used to transmit torques from one shaft to another. Such couplings can for example be rigid or elastic couplings, or switchable or non-switchable couplings. Couplings also provide a rigid, torsionally rigid, elastic, torsionally flexible and/or movable connection between two shafts, wherein the couplings can compensate for torque shocks and/or angular errors between the shafts.

From DE 20 2015 008 453U1 , a wedge pack ring for couplings with two coupling parts is known, in which there is at least a plurality of fastening elements arranged circumferentially around the ring and directed towards the ring axis of the wedge pack ring, each having at least one through-bore directed exclusively radially to the ring axis. The bores are used for at least one exclusively radially directed screw connection, which can be carried out from the outer region of the ring, for fastening the fastening elements to two adapted coupling parts to connect the two coupling parts. Between the adjacent fastening elements there is in each case an elastic spring element which is fastened by vulcanization onto the adjacent fastening elements in a simultaneously carried out vulcanization process, so that an alternating arrangement of the fastening elements and the elastic spring elements represents the wedge pack ring which can be screwed radially onto the two adapted coupling parts to connect the two coupling parts. The wedge pack ring is formed and divided from at least two one-piece ring segments from an alternating arrangement of the fastening elements and the spring elements.

From DE 1 286 831 B, an elastic coupling for large swivel angles is known, which comprises multiple torque-transmitting sheet steel disks combined in pairs, which are connected to the adjacent pairs on the outer or inner circumference and are combined into a freely oscillating pair on the other circumference. The sheet steel disks are provided from one circumference, preferably from the inner circumference, with a plurality of substantially radial slots, wherein the trapezoidal tongues formed by the slots and located opposite one another in the pairs are firmly connected to one another at their free ends.

In addition, EP 0 498 235 B1 discloses a diaphragm coupling with perforated contour diaphragms for the torsionally rigid, flexurally elastic connection of torque-carrying drive elements with at least one compensation plane and at least one diaphragm between the connecting parts. The thickness of the elastic diaphragm region decreases towards the outside, with apertures and/or beads being arranged in the elastic diaphragm region.

The solutions known from the prior art have the disadvantage that the elastic couplings are complex, material-intensive and expensive. Another disadvantage is that the compensation behavior is inadequate, in particular in the case of angular and radial misalignment, and the wear is high due to the multi-dimensional stress.

The object of the present invention is to provide an elastic coupling which can be produced in a weight-optimized, simple and cost-effective fashion and has improved compensation behavior, in particular with regard to angular, axial and radial misalignment, with low wear.

The object is achieved by the invention indicated in the claims. Advantageous embodiments are the subject of the subclaims.

The solution according to the invention provides a spatially elastic coupling which can be produced in a weight-optimized, simple and cost-effective fashion and allows for improved compensation behavior, in particular with regard to angular, axial and radial misalignment, in particular when angular, axial and radial misalignment occurs between a driving unit and a driven unit or coupling, with low wear behavior.

According to the invention, a spatially elastic coupling is provided for connecting a driving unit and a driven unit, comprising at least a first and second connecting element extending radially to the axis of rotation, and at least one rotationally symmetrical torsionally and flexurally elastic stiffness module, wherein the first and second connecting elements are arranged coaxially to one another and are connected by the torsionally and flexurally elastic stiffness module, and wherein the torsionally and flexurally elastic stiffness module extends coaxially to the axis of rotation of the coupling and radial, axial and/or angular misalignment between a driving and/or driven unit or another spatially elastic coupling can be compensated for.

Advantageously, the torsionally and flexurally elastic stiffness module is formed from a plurality of connecting pieces and/or columns in a single or multiple monopteros arrangement or as a cylindrical lattice structure, which coaxially connect the first and second connecting element and is or are arranged rotationally symmetrically, wherein in particular the connecting pieces and/or columns are arranged parallel, V-shaped, X-shaped, meandering and/or multiply crossed.

In an advantageous embodiment, the connecting pieces and/or columns are manufactured in a sandwich construction and the core is formed with a honeycomb structure, foam structure and/or meander-shaped support structure.

In addition, it is advantageous if at least one torsionally and flexurally elastic stiffness module has a cross-sectional taper or cross-sectional widening in at least one partial portion.

It is also advantageous if at least the torsionally and flexurally elastic stiffness module is made of steel, titanium, elastomer, plastics material and/or a fiber composite material.

Advantageously, it can be provided that the first and second connecting elements and at least one torsionally and flexurally elastic stiffness module are materially uniform.

It is also advantageous if the coupling is designed in one piece.

In an advantageous embodiment, the coupling is connected to a tooth coupling, flange coupling, ring disk coupling, plate coupling, diaphragm coupling, lamellar coupling, friction coupling and/or to two shaft portions.

Also advantageously, at least one connecting element is designed as a diaphragm element with a radially tapered material cross section.

Advantageously, the first and/or second connecting element is disk-shaped, lamellar, rod-shaped or star-shaped.

Furthermore, at least one connecting element advantageously has axially extending recesses and/or apertures.

According to the invention, a coupling arrangement is provided comprising at least two spatially elastic couplings which are connected in series in an axially aligned manner and are connected with a non-positive fit, a positive fit, and/or a material bond. A particular technical advantage of the spatially elastic coupling according to the invention is that, in particular, the torsional and flexural rigidity of the coupling can be easily adapted and optimized to the provided conditions of use via material and design parameters in different regions of the coupling.

The aforementioned technical advantages and effects are achieved by a spatially elastic coupling which has at least one first and second connecting element and at least one torsionally and flexurally elastic stiffness module.

The first and second connecting elements are arranged coaxially to each other and can be connected with a non-positive fit, a positive fit, and/or a material bond through the elastic stiffness module.

In the context of the invention, a torsionally and flexurally elastic stiffness module is to be understood as a complex and spatially formed structure consisting of a plurality of three-dimensional elements arranged between the first and the second connecting elements and connecting them, which structure extends coaxially to the axis of rotation of the coupling and with which at least one radial, axial and/or angular misalignment between the driving and/or driven unit or another coupling can be compensated. The torsionally and flexurally elastic stiffness module can be exchangeably and detachably connected to the first and/or second connecting element.

The spatially elastic coupling is provided to connect a driving unit and a driven unit. A driving or driven unit can be for example a gear or motor unit or two shafts connected by the spatially elastic coupling.

In an advantageous embodiment, it can be provided that the spatially elastic coupling is connected to a further coupling via the first and/or second fastening element and thus, for example, the coupling can be used as a double cardanic coupling.

The first and second connecting elements are spaced apart from one another and arranged coaxially to one another and are connected by at least one torsionally and flexurally elastic stiffness module, so that the coupling is drum-like in shape.

In an advantageous embodiment of the coupling according to the invention, it can be provided that the torsionally and flexurally elastic stiffness module is formed from a plurality of connecting pieces or columns in a single or multiple monopteros arrangement or as a cylindrical lattice structure, which connect the first and second connecting element and are arranged rotationally symmetrically between them.

If the torsionally and flexurally elastic stiffness module is designed with a plurality of connecting pieces or columns in a single or multiple monopteros arrangement, the connecting pieces or columns, which are rotationally symmetrical and equidistant from one another, can be arranged parallel, V-shaped, X-shaped and/or multiply crossed. The formed monopteros can be provided in a simple circular arrangement or as a multiple coaxial circular arrangement, so that as a result the radial or angular compensation capacity as well as the stiffness of the spatially elastic coupling can be designed in a simple manner.

It is also conceivable that individual or all connecting pieces and/or columns are manufactured in a sandwich construction and their core is designed as a honeycomb structure, foam structure and/or meander-shaped support structure. The core can be made of a different material than the inner and outer cylinders of the columns or the inner and outer sandwich panels of the connecting pieces. The structural design of the connecting pieces and columns allows for a targeted influence on the stiffness of the elastic stiffness modules and thus compensates for not only radial misalignment but also torsional loads.

It is also conceivable that at least one or all torsionally and flexurally elastic stiffness modules have a cross-sectional taper or cross-sectional widening in at least one partial portion in order to optimize the applied collective load and the associated mechanical loading capacity of the stiffness module or the elastic stiffness modules.

In an advantageous embodiment of the spatially elastic coupling, it can be provided that, for example, the first or second connecting element is connected to a tooth coupling, flange coupling, ring disk coupling, plate coupling, diaphragm coupling, lamellar coupling or friction coupling.

It is also conceivable that, in order to compensate for any radial, axial and/or angular misalignment that occurs, the spatially elastic coupling is arranged between two shafts and is connected, for example via an additional spur gear, to the shaft ends of the two shafts in a positive-fitting and non-positive-fitting manner as a cardanic joint.

In an advantageous embodiment of the spatially elastic coupling, it can be provided that at least the torsionally and flexurally elastic stiffness module(s) is/are made of steel, titanium, an elastomer, a plastics material and/or a fiber composite material. It is conceivable that when low torsional stress occurs, at least the torsionally and flexurally elastic stiffness modules are made of plastics material or a glass-fiber-reinforced or carbon-fiber-reinforced composite material.

It is also conceivable that at least the elastic stiffness module is made of an elastomer and can thus advantageously compensate for axial misalignment in addition to compensating for radial and angular misalignment.

With regard to additive manufacturing of the spatially elastic coupling, it can advantageously be provided that the first and second connecting elements and the at least one torsionally and flexurally elastic stiffness module are materially uniform, and/or the coupling is manufactured in one piece. This allows for cost-and time-saving production, for example using 3D printing processes.

In order to provide a material-independent axial compensation behavior as well as an optimized stiffness and bending capacity of the spatially elastic coupling, it can be provided that at least one of the connecting elements has a radially extending tapered material cross section which acts as an additional elastic region. Axially extending recesses and/or apertures can also be provided at least in the connecting element. The above-described radial change in the material cross section or the provision of recesses or apertures represent geometric or structural elements in the design of the spatially elastic coupling, with which the in particular bending elasticity and the axial displacement capacity of the coupling can be easily influenced.

In order to achieve a double cardanic behavior of the coupling, it can be provided that two or more of the spatially elastic couplings described above are arranged and connected in series in axial alignment. The connection of the couplings can be established with a non-positive fit, a positive fit, or a material bond, via the corresponding connecting elements.

The invention is explained in more detail below on the basis of an exemplary embodiment. In the figures:

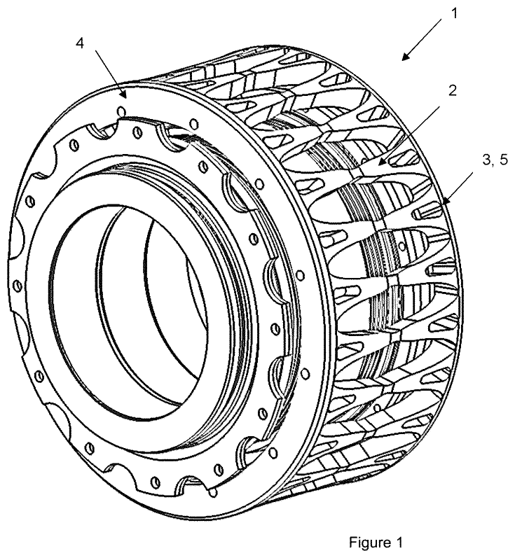

FIG. 1 shows a spatially elastic coupling in perspective view and

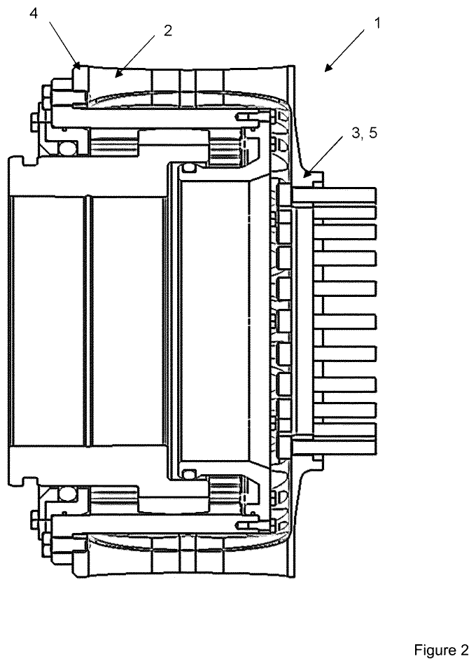

FIG. 2 shows a spatially elastic coupling in cross section.

### EXEMPLARY EMBODIMENT

FIG. 1 and FIG. 2 show a spatially elastic coupling 1 which is made in one piece and materially uniformly from steel, and is provided for use in a rail vehicle. The spatially elastic coupling 1 has a first disk-like connecting element 3 with circumferential bores directed axially to the ring axis, via which a driving unit (not shown) can be flange-mounted by screws and thus connected. The first disk-like connecting element 3 has a tapered material cross section in a partial region, by which a diaphragm element 5 is formed. A second disk-like connecting element 4 is connected to a sleeve of a tooth coupling. The sleeve has internal teeth that mesh with the external teeth of a hub. The first and second connecting elements 3 and 4 are connected by the coaxially arranged torsionally and flexurally elastic stiffness module, wherein the stiffness module is formed from a plurality of rods which are arranged in an X-shaped rotationally symmetrical manner between the first and second connecting elements 3 and 4 and extend parallel to the axis of rotation of the coupling 1. When a torque is applied and there is a radial and axial misalignment of the driving unit compared to the oppositely arranged tooth coupling and a downstream driven unit, via the X-shaped rods a dampening takes place of the torsional load, and the radial misalignment and the resulting angular misalignment are compensated for, wherein axial movements are dampened and compensated for via the produced diaphragm contour of the first connecting element.

### LIST OF REFERENCE SIGNS

1 Coupling
2 Torsionally and flexurally elastic stiffness module
3 First connecting element
4 Second connecting element
5 Diaphragm element

1. A spatially elastic coupling for connecting a driving unit and a driven unit, comprising at least a first and second connecting element extending radially to the axis of rotation, and at least one rotationally symmetrical torsionally and flexurally elastic stiffness module, wherein the first and second connecting elements are arranged coaxially to one another and are connected by the torsionally and flexurally elastic stiffness module, and wherein the torsionally and flexurally elastic stiffness module extends coaxially to the axis of rotation of the coupling and radial, axial and/or angular misalignment between a driving and/or driven unit or another spatially elastic coupling can be compensated for.

2. The coupling according to claim 1, wherein the torsionally and flexurally elastic stiffness module is formed from a plurality of connecting pieces and/or columns in a single or multiple monopteros arrangement or as a cylindrical lattice structure, which coaxially connect the first and second connecting element and is or are arranged rotationally symmetrically.

3. The coupling according to claim 2, wherein the connecting pieces and/or columns are arranged parallel, V-shaped, X-shaped, meandering and/or multiply crossed.

4. The coupling according to claim 2, wherein the connecting pieces and/or columns are manufactured in sandwich construction and the core is formed with a honeycomb structure, foam structure and/or meander-shaped support structure.

5. The coupling according to claim 1, wherein at least one torsionally and flexurally elastic stiffness module has a cross-sectional taper or cross-sectional widening in at least one partial portion.

6. The coupling according to claim 1, wherein at least the torsionally and flexurally elastic stiffness module is made of steel, titanium, elastomer, plastics material and/or a fiber composite material.

7. The coupling according to claim 1, wherein the first and second connecting elements and at least one torsionally and flexurally elastic stiffness module are formed from uniform material.

8. The coupling according to claim 1, wherein the coupling is made in one piece.

9. The coupling according to claim 1, which is connected to a tooth coupling, flange coupling, ring disk coupling, plate coupling, diaphragm coupling, lamellar coupling, friction coupling, and/or to two shaft portions.

10. The coupling according to claim 1, wherein at least one connecting element is designed as a diaphragm element with a radially tapered material cross section.

11. The coupling according to claim 1, wherein the first and/or second connecting element is disk-shaped, lamellar, rod-shaped or star-shaped.

12. The coupling according to claim 1, wherein at least one connecting element has axially extending recesses and/or apertures.

13. A coupling arrangement, comprising at least two spatially elastic couplings claimed according to claim 1, which are connected in series in an axially aligned manner and are connected with a non-positive fit, a positive fit, and/or a material bond.
